(19) United States
(12) Patent Application Publication
(10) Pub. No.: US 2005/0011092 A1
(43) Pub. Date: Jan. 20, 2005

(54) Award bar and holder combination

(75) Inventor: Robert Bruscini, Cumberland, RI (US)

Correspondence Address: George L. Greenfield;Wolf, Greenfield & Sacks, P.C., 600 Atlantic Avenue, Boston, MA, 02210, US

(73) Assignee: V. H. Blackinton & Co., Inc., Attleboro Falls, MA (US)

(21) Appl. No.: 10/621,671

(22) Filed: Jul. 17, 2003

(51) Int. Cl. A44C 3/00; G09F 3/12

(52) U.S. Cl. 40/1.6; 40/668

(57) ABSTRACT

An award bar holder for accommodating one or more separate award bars includes a C-shaped channel having a rear panel and forwardly extending side panels having lips at the front edges that extend toward one another. The channel adjacent each end has a pair of mounting pins with detachable clasps for securing the holder to a garment. The award bars are held in the channel by pressure members that cause the bars to bind against the inner surfaces of the lips.

### BACKGROUND OF INVENTION

### FIELD OF INVENTION

This invention relates to the display of commendation award bars such as given by the military, clubs and other organizations and commonly displayed on uniforms or other articles of clothing. In this application the terms “award bars” and “commendating bars” are intended to encompass such items as badges, name bars, insignia ribbon bars, etc.

Presently commendation bars are individually attached to the uniform or other clothing of the recipient and most frequently are displayed in clusters arranged in rows on the chest area. Because they are individually mounted, they frequently are misaligned with other award bars in the same row and/or are not disposed parallel to similar bars in other rows, which is unsightly and detract from the honor represented by the awards. The present invention avoids such problems in the display of the commendation award bars and reduces the number of attachments that must be made to the clothing when multiple award bars are displayed.

### SUMMARY OF INVENTION

In accordance with the present invention, one or more commendation bars is mounted in a holder which in turn is connected to the clothing. The holder is channel-shaped with the side walls of the channel having lips at their free edges to retain the bars on the front of the holder. Pressure plates are formed in the channel to cause the bars to bind against the lips and plates so as to prevent the bars from slipping out the ends of the channel. The holders are made in different sizes so as to be capable of supporting one, two, three or more bars.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a front view of one embodiment of a commendation award bar holder with three award bars in place, constructed in accordance with the present invention;

FIG. 2 is a front view of the holder shown in FIG. 1 with the award bars removed;

FIG. 3 is a rear view of the holder shown in FIG. 2;

FIGS. 4 and 5 are cross-sectional views of the holder and bar taken respectively along section lines 4-4 and 5-5 in FIG. 1;

FIGS. 6 and 7 are front views similar to FIG. 2 of additional embodiments of the award bar holder for holding two and one award bars, respectively; and

FIG. 8 is an enlarged detail perspective view of one pin and clasp shown in FIGS. 3-5 for attaching the holder to a garment.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

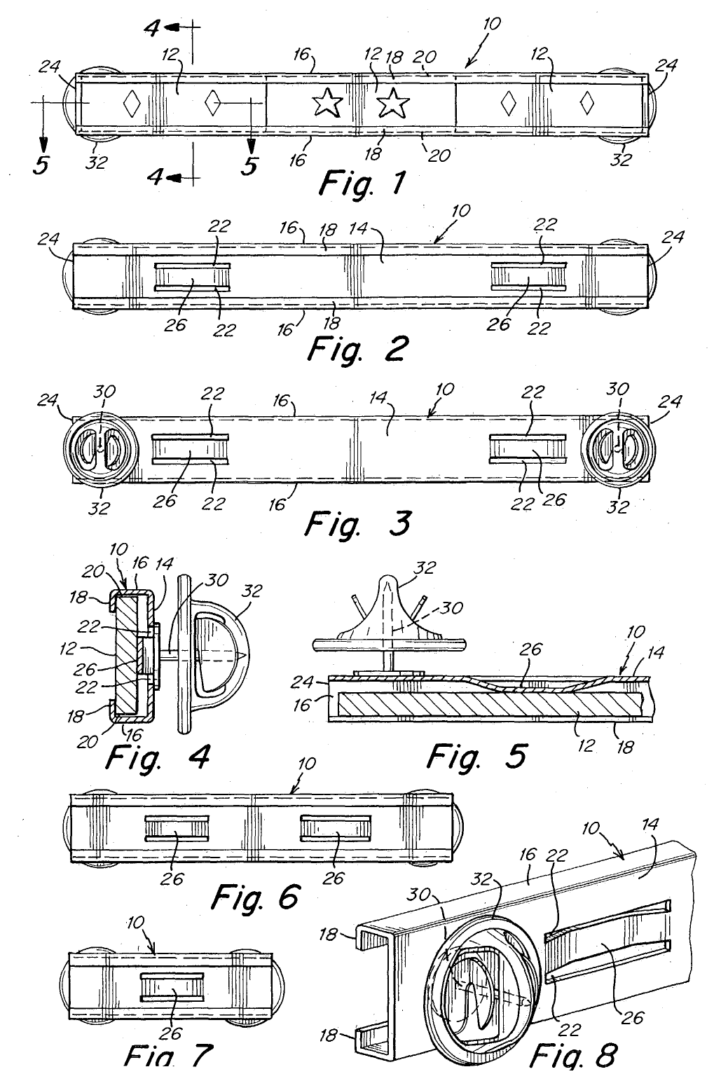

The present invention may be embodied in several different sizes so as to mount one or several separate commendation award bars as well as bars of different dimensions. In the embodiments illustrated, commendation bar holders are shown for holding one, two or three bars, and it should be understood that the holders may be made to accommodate greater numbers if desired. The holders illustrated in FIGS. 1, 6 and 7 are intended to accommodate three, two, and one commendation award bars, respectively. Aside from their length, the different holders are essentially the same except for the location of the pressure plates that hold the bars in the holders.

Each of the holders in the preferred embodiments illustrated is made of a flat, preferably rolled metal stock such as a copper, zinc, or tin alloy that typically may be 0.015 inch in thickness and 2 inches wide. While the embodiment shown is made of metal, it is to be understood that the holder may be made of other materials such as plastics, wood, ceramics, etc. In FIGS. 1-5 one embodiment of the award bar holder is illustrated. The holder 10 as shown carries three award bars 12 each physically separate and independent of the others. The award bars 12 typically may be made from the same metal alloy or other material as the holder but is normally approximately ______ inches in thickness, 0.40 inches wide and 1.75 inches long. While specific dimensions are suggested in this description, it is to be appreciated that the dimensions may be greatly varied, but obviously the dimensions of the bars will dictate the dimensions of the holders. The indicia carried by the award bars, may be stars, stripes, logos, badges, names, etc. die struck into the surface of the bars and they may or may not be coated with enamel or other material. The indicia may also be mounted on the bars.

The channel-shaped holder 10 includes a back panel 14 that preferably is flat and a pair of side panels 16 essentially perpendicular to the back panel 14. The free ends of the side panels carry lips 18 that extend toward one another so as to overlap the longitudinal edges 20 of the award bars 12.

As is clearly illustrated in FIGS. 1 and 2, two pairs of rectangular openings 22 are provided in the back panel 14, each pair spaced inwardly from the ends 24 of the holder so as to be approximately centered with respect to the award bar adjacent each end of the holder. The openings 22 define between them pressure plates that are bowed forwardly (out of the plane of the back panel 14) so as to bear against the backs of the award bars in front of them to push the bars firmly against the lips 18. That action captures the award bars at the ends of the holder so that they will not slide out the holder ends 24. The center award bar is trapped between the end award bars and is therefore also prevented from sliding out of the holder. Preferably the plates 26 provide a smooth camming surface at each end to enable the award bars to slide on and off the crowns of the plates. The pressure plates 26 may be of different configuration. For example, the sides need not be parallel, and although it is preferred that the pressure plates be attached at each end to the major portion of the back panel 14, they need not be. Moreover, the pressure on the bars may be exerted by many different types of devices. For example, a spring arrangement may be separately fabricated and thereafter attached to the holder body or leaf springs may be mounted on the inside of the lips to urge the bars against the rear panel 14, although the illustrated embodiments are preferred.

The back of the back panel 14 of the holder 10 carries a pair of pins 30, one adjacent each end of the holder (see FIGS. 3, 4, 5 and 8). The pins 30 are designed to extend through the article of clothing or other material to which the holder with the award bars is to be attached. Each pin 30 has a removable clasp 32 that attaches to it so as to hold the pin in place on the material and cover the point of the pin so as not to stick the wearer. Preferably the clasps are of the clutch type that are well known, having grippers that are spring loaded to engage the shaft of the pin and that are removed by squeezing a pair of tabs together that are connected to the grippers so as to overcome the spring bias and separate them so that they release the pin.

In FIGS. 6 and 7 other embodiments for respectively holding two and a single aware bar are shown. They are virtually the same as the embodiment of FIGS. 1-5 except for their length. While the holder of FIG. 1 may be approximately 4.25 inches in length, those shown in FIGS. 6 and 7 may be approximately 2.875 and 1.375 inches long, respectively. In the embodiment of FIG. 6 a pressure plate 26 is provided for each of the two award bars to be mounted in the holder, and in the embodiment of FIG. 7 just one pressure plate 26 is provided in the approximate center of the holder to engage the single award bar to be mounted in it. Each of these embodiments has a pair of pins and clasps like that of the embodiment of FIG. 1 to attach the holders to clothing.

While a generally rectangular configuration for the holder is shown in each of the embodiments illustrated, it is to be understood that the bottom panel as well as the side panels of the holder may be somewhat curved, but it is highly desirable that the cross section of the interior space of the holder conforms to the cross section of the bars to accommodate the commendation bars and prevent them from rattling in the holder.

Having thus described several aspects of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. An award bar holder comprising
a generally C-shaped elongated channel member having a flat back panel and side panels that extend toward one another in a forward direction from each longitudinal side edge of the back panel, said back and side panels forming a slide seat for receiving one or more award bars,
at least one pin attached to the back side of the back panel for piercing a fabric-like material on which the holder is to be mounted,
a clasp removably carried on the end of each pin for securing the holder to the fabric by preventing withdrawal of the pin from the fabric,
and a pressure member formed in the back panel of the holder for pushing an award bar disposed in the slide seat in a forward direction against the side panels to prevent the award bar from slipping out of the slide seat.

2. An award bar holder as described in claim 1 wherein the member is a raised segment in the back panel extending forwardly of the plane of the front surface thereof.

3. An award bar holder as described in claim 1 wherein the member is integrally formed as part of the back panel.

4. An award bar and holder combination comprising at least one award bar having a pair of parallel side edges,
a generally C-shaped holder having side walls that overlap the side edges of the award bar so that the side edges are captured under the side walls of the holder,
a pressure member in the holder for bearing against the award bar causing the bar to press against the side walls of the holder to resist sliding of the bar in the holder,
an at least one fastener mounted on the back of the holder for securing the holder to a support.

5. An award bar and holder combination as defined in claim 4 wherein the holder has a back panel and the pressure member is formed as an integral part of the back panel and bears against the back of the award bar.

6. An award bar and holder combination as defined in claim 5 wherein the pressure member is a segment of the back panel displaced toward the front of the holder.

7. An award bar and holder combination comprising
an elongated holder having a back panel with front and back sides and a pair of longitudinally extending top and bottom edges,
a pair of side panels attached to the back panel and extending forward of the front side thereof, said side panels having lips that extend toward one another spaced from and in front of the front face of back panel,
at least one award bar disposed in the holder on the front side of the back panel and behind the lips of the side panels,
and a pressure member on the holder urging the award bar to bind on the lips for preventing the bar from sliding off the ends of the holder.

8. An award bar and holder combination as described in claim 7 wherein an attaching member is connected in the back side of the back panel for mounting the holder on a garment.

9. An award bar and holder combination as described in claim 8 wherein the attaching member comprises a pair of pins and clasps.

10. An award bar and holder combination as described in claim 8 wherein the holder is at least twice as long as an award bar for holding two or more of said bars.

11. An award bar and holder combination as described in claim 8 wherein the pressure member is a plate that projects forwardly of the front side of the back panel.

12. An award bar and holder combination as described in claim 7 wherein the holder is sized to simultaneously hold at least three award bars in a row, and
pressure members are provided adjacent the ends of the holder to engage the end award bars in the holder.

13. An award bar and holder combination as described in claim 8 wherein the pressure member is defined by slots in the back panel that form a plate and the plate is displaced from the plane of the back panel.

14. An award bar and holder combination as described in claim 7 wherein the back panel, side panels and pressure member are integrally formed from a single metal strip.
